(19) United States
(12) Patent Application Publication
(10) Pub. No.: US 2013/0198786 A1
(43) Pub. Date: Aug. 1, 2013

(54) Immersive Environment User Experience

(71) Applicants: Michael Cook, Flemington, NJ (US); Labeeb Ismail, San Francisco, CA (US); John D. Kennedy, San Francisco, CA (US)

(72) Inventors: Michael Cook, Flemington, NJ (US); Labeeb Ismail, San Francisco, CA (US); John D. Kennedy, San Francisco, CA (US)

(73) Assignee: Comcast Cable Communications, LLC., Philadelphia, PA (US)

(21) Appl. No.: 13/804,208

(22) Filed: Mar. 14, 2013

Related U.S. Application Data
(63) Continuation-in-part of application No. 13/326,617, filed on Dec. 15, 2011.
(60) Provisional application No. 61/567,783, filed on Dec. 7, 2011.

(51) Int. Cl. H04N 21/436

(52) U.S. Cl. CPC H04N 21/43615
USPC 725/81; 725/78

(57) ABSTRACT

Systems, methods, software, and data structures that provide an immersive user experience are disclosed. A video program may be associated with predefined actions to be performed by one or more dynamic devices near the video device. Dynamic devices may perform actions in synchronization with the media program. Dynamic devices may be wirelessly controlled, and different versions of a media program may be served to different receiving devices based on the set of dynamic devices known to be associated with each receiving device.

### CROSS-REFERENCE TO RELATED APPLICATIONS

This application claims priority to and is a continuation in part of co-pending application Ser. No. 13/326,617, filed Dec. 15, 2011, entitled “Dynamic Ambient Lighting”, which claims priority to provisional application No. 61/567,783, filed Dec. 7, 2011, also having the title “Dynamic Ambient Lighting,” each of which is herein incorporated by reference for all purposes.

### BACKGROUND

Viewing of media programs (e.g., television programs, movies, streaming video, and the like) has become increasingly popular as the cost of movie theater-like televisions, screens, and sound systems become more affordable for mainstream consumers. However, there remains an ever-present need to improve the viewing experience and immersion level for viewers.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to systems and methods that dynamically control one or more objects, such as devices that are disposed near a media consumption apparatus, the dynamic control may implemented in synchronicity with a media program being viewed on the media consumption apparatus. According to one aspect, lighting in a video viewing environment (e.g., a retail, commercial, or domestic environment) may be dynamically altered to enhance a viewing experience while watching a media program such as a television show, advertisements or informational productions, on-line video game, streaming video, movie, or the like. According to another aspect, a consumer electronic device, such as an animatronic stuffed animal, may be controlled to perform some action or play back a particular audio file at a time specified by instructions contained in a media transmission, e.g., a content stream, such instructions may be wirelessly transmitted to the one or more objects after being processed, e.g., when associated content is being presented, by the media consumption device or another device.

According to a first aspect, a method includes receiving a media transmission over a network connection, where the media transmission comprises a media program as an audio component, a video component, and one or more, e.g. a series of, dynamic media packets. The method may include outputting the video component to a video display device, outputting the audio component to one or more speakers associated with the video display device, and outputting instructions associated with the dynamic media packets to a dynamic device associated with the dynamic media packet. The dynamic media packet may define an action to be performed by the dynamic device at a predefined time associated with the media program.

Another aspect provides a device comprising a processor, a network input/output port, video output port, an audio output port, a wireless transceiver, and memory storing instructions that, when executed by the processor, configure the device to perform various actions, such as receiving a media stream over the network input/output port, where the media stream defines a media program as an audio component, a video component, and dynamic media packets. The device outputs the video component via the video output port, outputs the audio component via the audio output port, and outputs the instructions associated with the dynamic media packets via the wireless transceiver to a dynamic device associated with the dynamic media packet. The dynamic media packet defines an action to be performed by the dynamic device at a predefined time within the media program.

According to yet another aspect a computing device includes a processor and memory storing instructions that, when executed by the processor, configure the server device to perform various actions, such as receiving a request from a first user device for a media program, and determining a first set of one or more dynamic devices known to be associated with the first subscriber device. The server device determines a first version of the media program, from a plurality of versions of the media program, based on the first set of one or more dynamic devices, and transmits the first version of the media program to the first subscriber device.

These and other aspects will be readily apparent upon reviewing the detailed description below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative embodiment of a network according to one or more aspects described herein.

FIG. 2 shows an illustrative hardware and software platform on which the various elements described herein may be implemented according to one or more aspects described herein.

FIG. 3 shows an illustrative diagram of a light source according to one or more aspects described herein.

FIG. 4 shows an illustrative room environment for a lighting system according to one or more aspects described herein.

FIG. 5 shows an illustrative data structure according to one or more aspects described herein.

FIG. 6 shows an illustrative data structure for a lighting effect according to one or more aspects described herein.

FIG. 7 shows an illustrative data structure for a lighting effect according to one or more aspects described herein.

FIG. 8 shows an illustrative data structure for a lighting scheme according to one or more aspects described herein.

FIG. 9 shows an illustrative method for dynamic lighting according to one or more aspects described herein.

FIG. 10 shows an illustrative method for dynamic lighting based on a predetermined lighting scheme according to one or more aspects described herein.

FIG. 11 shows an illustrative data structure according to one or more alternative aspects described herein.

FIG. 12 shows an illustrative method for pairing a plurality of position-dependent devices with a device controller according to one or more alternative aspects described herein.

FIG. 13 shows an illustrative display during a pairing process according to one or more alternative aspects described herein.

FIG. 14 shows an illustrative display during a pairing process according to one or more alternative aspects described herein.

FIG. 15 shows a format of a data packet that may be used to communicate instructions according to one or more alternative aspects described herein.

FIG. 16 shows a method for dynamically controlling a device according to one or more alternative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

Illustrative aspects described herein provide methods and system for providing an immersive user experience while viewing a media program, based on the content of the media program (e.g., video, television, movie, interactive web site, etc.), by interacting with one or more objects, such as devices, external to the media program viewing device (e.g., a television) in use. The external device(s) may include dynamic lights, toys, sound generators, wind generators, olfactory emitters, lasers, smoke machines, heat sources, rain generators, microphones, or any other objects that can communicate with a controller as described herein. Such objects may be referred to herein as dynamic devices.

First illustrative aspects provide methods and system for dynamically altering lighting in a room when a media program is playing, based on the content in the media program. Stated differently, some aspects described herein define how to alter ambient lighting based on the content in a television show, movie, or other video program. For example, during a sunrise scene in a video program, ambient lighting might get stronger to enhance the viewer's sensory perception of the sun rising; during a sunset the ambient lighting might be reduced to enhance the viewer's sensory perception of the sun going down; during a scene in which a police car is shown with flashing lights, ambient lighting might increase and decrease in alternating cycles between left and right portions of the room to enhance the viewer's sensory perception of a police car with flashing lights. A large number of embodiments exist based on the content being shown in a media program. Aspects described herein define methods and systems defining lighting schemes, associating lighting schemes with a video program, communicating the lighting information to a viewer's terminal equipment, and controlling lighting within a room based on the received lighting information.

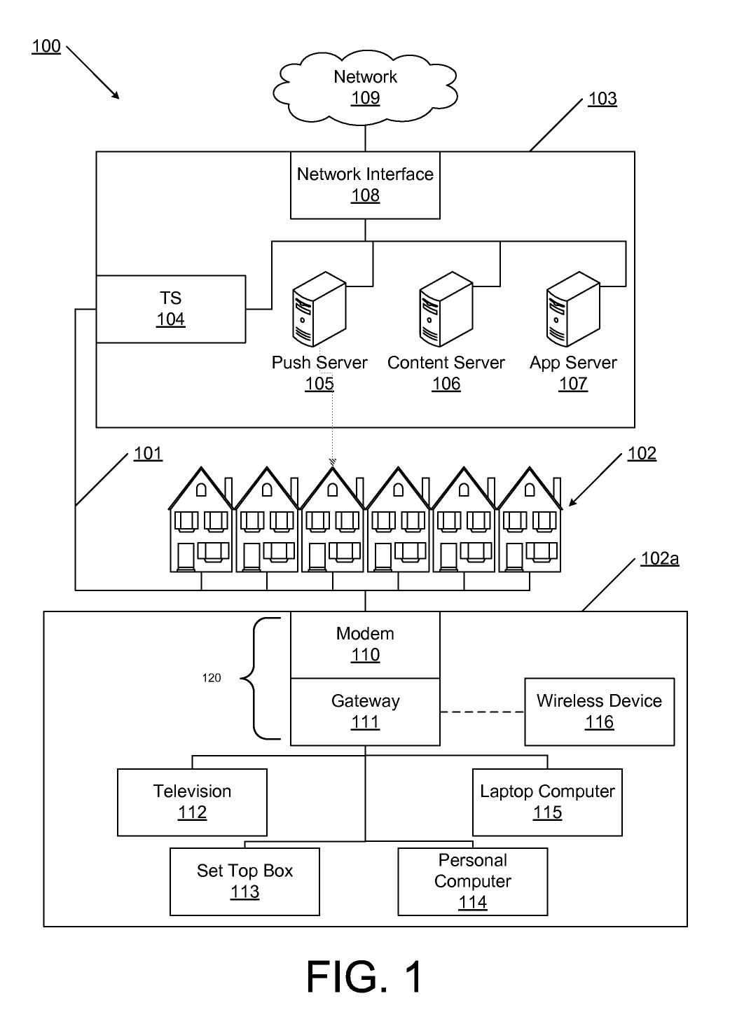

FIG. 1 illustrates an example of an information distribution network 100 in which many of the various features described herein may be implemented. Information distribution network 100 may be any type of information distribution network, such as fiber, coax, hybrid fiber/coax, wired, LAN, WAN, satellite, telephone, cellular, wireless, etc. Illustrative information distribution networks 100 may use one or more (e.g., a series of) communication links 101 (e.g., channels, lines, coaxial cables, LAN, WAN, optical fibers, wireless, etc.) to connect multiple premises 102 (e.g., businesses, offices, apartment buildings, homes, consumer dwellings, etc.) to a central location 103 (e.g., a local service office, telephone central office, server room, video headend, etc.). The central location 103 may transmit downstream information signals onto the channels 101, and each premises 102 may have a receiver used to receive and/or process those signals.

There may be one or more communication channels 101 originating from the central location 103, and the communication channels may traverse one or more different paths (e.g., lines, routers, nodes, hubs) to distribute the signal to various premises 102 which may be, for example, many miles distant from the central location 103. The communication channels 101 may include components not illustrated, such as splitters, filters, amplifiers, etc. Portions of the communication channels 101 may also be implemented with fiber-optic cable, while other portions may be implemented with coaxial cable, other lines, or wireless communication paths.

The central location 103 may or may not include an interface 104 (such as a termination system (TS), router, modem, cable modem termination system, fiber termination system, etc.) which may include one or more processors configured to manage communications between devices on the communication channels 101 and/or backend devices such as servers 105-107 (to be discussed further below). Interface 104 may be as specified in a suitable communication standard, such as the Data Over Cable Service Interface Specification (DOCSIS) standard, published by Cable Television Laboratories, Inc. (a.k.a. Cable Labs), 802.11, FDDI, MPLS. Interface 104 may also use a custom standard such as a similar or modified interface device to a standard interface. Interface 104 may be variously configured to include time division, frequency division, time/frequency division, wave division, etc. In one illustrative embodiment, the interface 104 may be configured to place data on one or more downstream frequencies to be received by modems at the various premises 102, and to receive upstream communications from those modems on one or more upstream frequencies. The central location 103 may also include one or more network interfaces 108, which can permit the central location 103 to communicate with various other external networks 109. These external networks 109 may include, for example, networks of Internet devices, telephone networks, cellular telephone networks (3G, 4G, etc.), fiber optic networks, local wireless networks (e.g., WiMAX), satellite networks, PSTN networks, internets, intranets, the Internet, and/or any other desired network. The interface 108 may include the corresponding circuitry needed to communicate on the external network 109, and/or to other devices on the external.

As noted above, the central location 103 may include a variety of servers 105-107 that may be configured to perform various functions. For example, the central location 103 may include a push notification server 105. The push notification server 105 may generate push notifications to deliver data and/or commands to the various premises 102 in the network (or more specifically, to the devices in the premises 102 that are configured to detect such notifications, e.g., ambient lighting devices). The central location 103 may also include a content server 106. The content server 106 may be one or more processors/computing devices that are configured to provide content to users in the premises. This content may be, for example, video on demand movies, television programs, songs, text listings, etc. The content may include associated lighting instructions. The content server 106 may include software to validate user identities and entitlements, locate and retrieve requested content, encrypt the content, and initiate delivery (e.g., streaming) of the content to the requesting user and/or device. The content server 106 may also include segmented video where lighting instructions are inserted into the video and associated with particular segments of video.

The central location 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. The program guide may be variously configured. In one embodiment, the program guide will display an indication (e.g., an icon) indicating that the program is ambient lighting enabled. For example, the program guide may include an icon of a static or dynamically changing light bulb indicating that the particular program is ambient lighting enabled. Another application server may be responsible for monitoring user viewing habits and collecting that information for use in selecting advertisements. Additionally, the lighting instructions may be included in advertisements. In one illustrative embodiment, the room brightens markedly when an advertisement appears on the program. Another application server may be responsible for formatting and inserting advertisements in a video stream being transmitted to the premises 102. Another application server may be configured to operate ambient lighting devices manually via controls input by the user from a remote device such as a remote control, IPHONE, IPAD, tablet, laptop computer, and/or similar device. Still referring to FIG. 1, an illustrative premises device 102a, such as a gateway device or set top box, may include an interface 120. The interface 120 may comprise a modem 110, which may include one or more transmitters, receivers etc., used to communicate on the communication channels 101 and with the central location 103. The modem 110 may be, for example, a coaxial cable modem (for coaxial cable communication channels 101), a fiber interface node (for fiber optic communication channels 101), a wireless modem (for wireless communication channels 101), and/or any other desired modulation/demodulation device. The modem 110 may be connected to, or be a part of, a gateway interface device 111. The gateway interface device 111 may be a computing device that communicates with the modem 110 to allow one or more other devices in the premises 102 to communicate with the central location 103 and other devices beyond the central location. The gateway 111 may be a set-top box (STB), digital video recorder (DVR), computer server, fiber interface device, media gateway, router, wireless router, and/or other desired computing device. The gateway 111 may also include (not shown) local network interfaces to provide communication signals to devices in the premises, such as televisions 112, additional STBs 113, personal computers 114, laptop computers 115, wireless devices 116 (wireless laptops and netbooks, mobile phones, mobile televisions, personal digital assistants (PDA), etc.), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11), Bluetooth interfaces, etc.

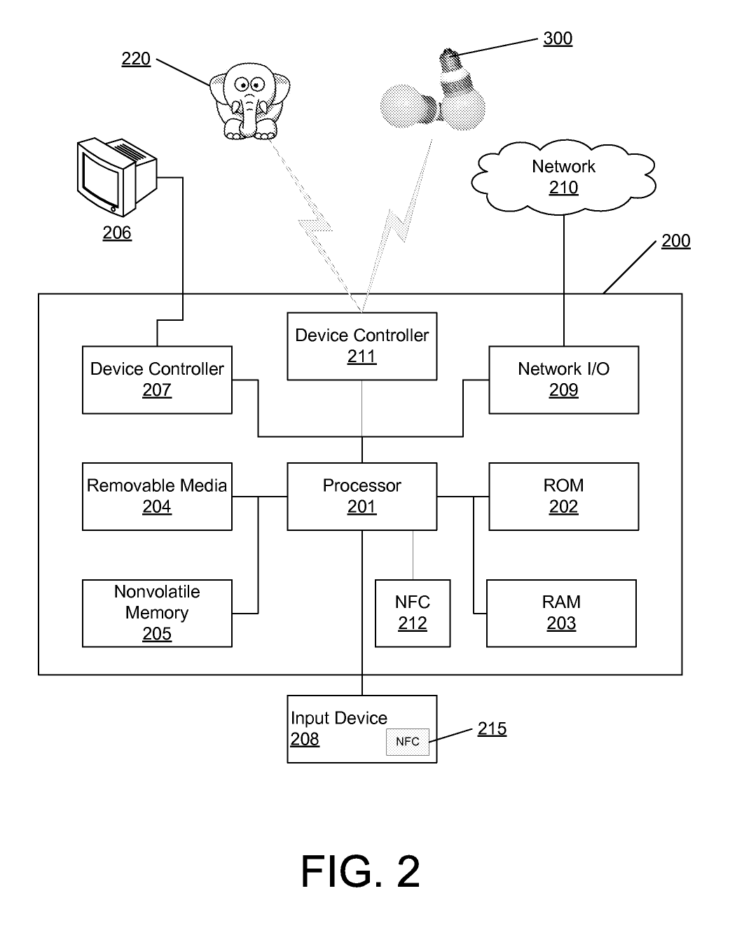

FIG. 2 illustrates general hardware and/or software elements that can be used to implement any of the various devices discussed herein. In illustrative embodiments, the computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. Instructions may also be stored in an attached (or internal) hard drive 205. The computing device 200 may include one or more output devices, such as a display 206 (or an external television), and may include one or more output device controllers 207, such as a video processor. There may also be one or more user input devices 208, such as a remote control, keyboard, smart phone, tablet, mouse, touch screen, microphone, etc. The computing device 200 may also include one or more network interfaces, such as input/output circuits 209 (such as a network card) to communicate with an external network 210. The network interface may be a wired interface, wireless interface, and/or fiber interface, etc. In some embodiments, the interface 209 may include a modem (e.g., a cable modem). In embodiments, network 210 may include communication channels 101 discussed above, the external network 109, an in-premises network, a provider's wireless, coaxial, fiber, or hybrid fiber/coaxial distribution system (e.g., a DOCSIS network), or any other desired network.

Device controller 211 (e.g., a lighting controller in this example) may dynamically control one or more dynamic devices 220 (e.g., including one or more light sources 300 such as a light fixture and/or the bulb therein), as further described herein, via one or more networks, e.g., wireless, wired (e.g., IP, DLNA, etc.), powerline, Wi-Fi, Bluetooth, infrared (IR), Z-Wave, and/or ZigBee-compliant networks (e.g., RF4CE or ZigBee Pro). Presently there exist approximately 1 billion incandescent light sources in residential premises in the US. Aspects of this disclosure makes these light sources much more versatile, controllable, and adaptable to the users. Device 220 is representative of a generic device controllable as described herein. Dynamic devices may include, but are not limited to, dynamic lights, toys, sound generators, wind generators, olfactory emitters, lasers, smoke machines, heat sources, rain generators, microphones, or any other device that can communicate with or be controlled by a device controller as described herein.

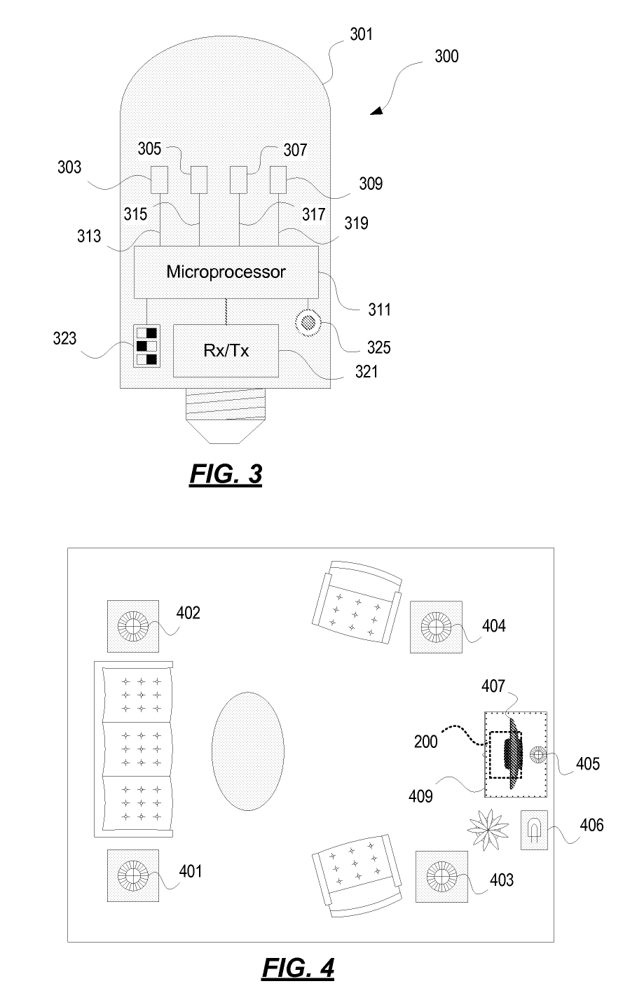

With reference to FIG. 3, an illustrative device 220 as light source 300 is shown. In this embodiment, the light source 300 may be configured as a 4-color LED. The 4-color LED bulb may be variously configured to contain strands of light emitting diodes (LEDs). These LEDs can be manufactured in any color. Light source 300 may be variously configured to include clear, red, blue, and green LED strands, giving light source 300 the ability to create any color and light intensity possible with any frequency based on changing the intensity levels of various strands.

Light source 300 may also include a housing 301 in which any number of LEDs may be included (e.g., four light emitting diode strands 303-309). Housing 301 may include a standard base so that the light source 300 can be screwed into any conventional lamp or fixture. The LEDs within the light source 300 may be variously configured. For example, LED 303 may include a red LED; LED 305 may be blue LED; LED 307 may be a green LED; LED 309 may be a high intensity white LED. LEDs 303-309 may be connected to, for example, one or more processors 311 using any suitable means such as control logic and/or via control wires 313, 315, 317, 319, respectively. Processor 311 may be variously configured. In one illustrative embodiment, processor 311 is manufactured by Marvell Technology Group Ltd. of Bermuda and Santa Clara, Calif., and is configured to control the LED strands within the light source, e.g., turning up or down the intensity, or “volume”, of one or more of the LED strands.

In illustrative embodiments, the light source 300 may be configured to include a media access control address (e.g., MAC address). The Mac address may register with the computing device 200 and/or with devices located proximate to the central location 103. In illustrative embodiments, the processor 311 (or light source 300) is initially manufactured having a unique media access control (MAC) address. The processor 311 may control the LEDs based on communication signals (e.g., lighting instructions) received via transceiver 321, when those communication signals are addressed to the MAC address associated with that light source. Transceiver 321 may be variously configured to include, for example, a Wi-Fi, Bluetooth, IEEE 802.15.4, or ZigBee-compliant transceiver. Light source 300 may further include one or more dip switches 323 to set various parameters associated with the light source 300, and may further include an input button 325 which may be used to place light source 300 in a designated mode, e.g., a pairing mode, as further described herein.

According to some embodiments, transceiver 321 may instead consist only of a receiver, and not include the ability to output send data. According to other embodiments, light 300 might include only 3 LEDs, omitting the high-intensity white LED. Light source may be variously configured such that processor 311 and/or transceiver 321 may be mounted in the base of the housing 301. In illustrative embodiments, an application downloadable to a remote control device (e.g., an i-Pad/i-Phone) may be utilized to set and/or control the light source either alone and/or in conjunction with the lighting instructions. The remote control may override the lighting instructions and/or enable the lighting instructions. Further, the remote control may set parameters for the lighting instructions such as minimum lighting levels.

With reference to FIG. 4, a room 400, or any other media consumption environment, may include multiple light sources (e.g., lamps 401-405). In this example, each of the light sources 300 use the illustrative light source 300 as shown in FIG. 3. In this example, each lamp 401-405 may be a common household lamp (floor lamp, table lamp, light fixture, recessed light, etc.) using a light source 300 as described herein. Lamp 406 may include a special high-intensity bulb that, when lit to a high intensity, significantly lights up the entire room. Lamp 406 may be referred to as a burst lamp, akin to a subwoofer of light, whereby an intense brightness is generated to provide a sudden sensation of light. Lamp 401 may be placed in a rear right position with respect to a viewing angle of television 407; lamp 402 may be placed in a rear left position; lamp 403 may be placed in a front right position; lamp 404 may be placed in front left position; and lamp 405 may be placed behind TV 407 in a center position. Lamp 406 may be placed in a discreet position, e.g., behind a plant or other obstacle, so as to prevent a viewer from looking directly at lamp 406 when lamp 406 is fully engaged. The remote control device may associate the light sources 300 with a planar view of the area such as that shown on FIG. 4. Using ranging or other suitable mechanisms, the light sources may detect the distance from for example, the television and/or set top device, and then display the relative location on a control device (e.g., an IPAD or other tablet device).

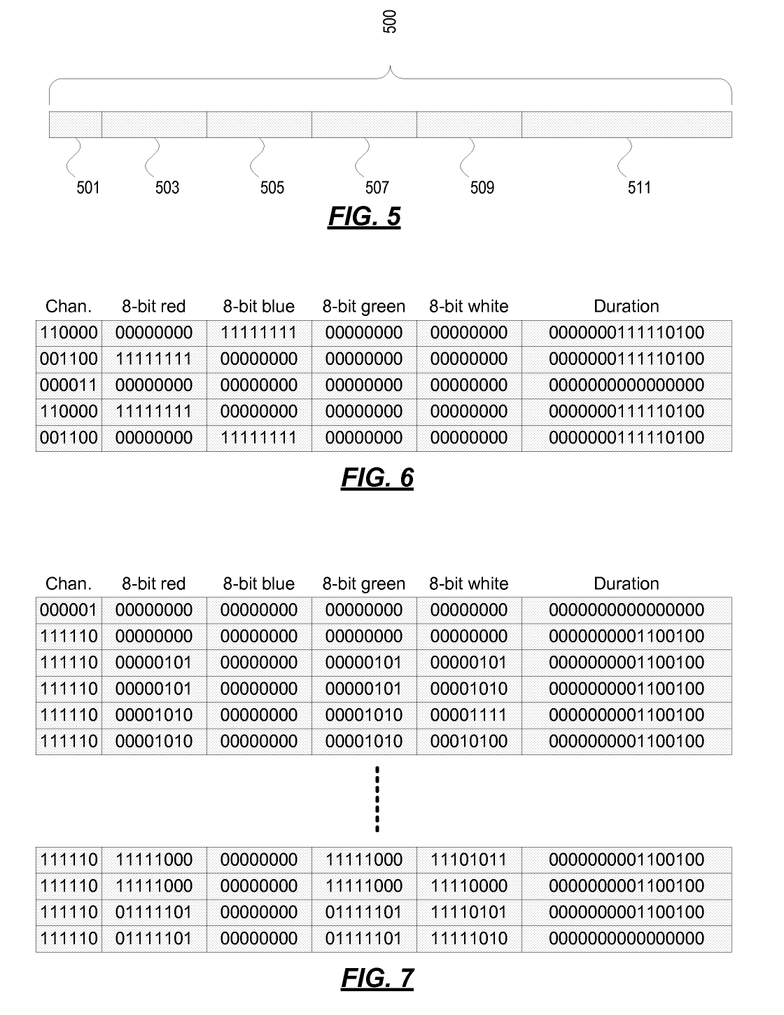

Each light source 300 may be controlled by its respective internal processor 311. Each processor, in turn, may control the LEDs in that light source based on instructions received via wireless transceiver 321. These instructions may be manual instructions from a remote and/or lighting instructions as discussed above. According to one illustrative aspect, with reference to FIG. 5, the instructions received via transceiver 321 may be received as a sequence of primitives 500, where each primitive identifies a MAC address 501, a sequence of raw intensity values 503, 505, 507, 509, followed by a duration 511. MAC address 501 may be configured to identify a lamp 401-406 within room 400. Intensity values 503-509 may be variously configured and in illustrative embodiments use an 8-bit relative intensity value for each of LEDs 303, 305, 307, 309, respectively, where 0 is off, and 11111111 indicates full intensity. Duration 511 may also be variously configured and in one illustrative embodiment includes 16 bits to indicate, in milliseconds, how long the microprocessor should maintain that state before either reverting to a previous state or implementing a subsequently received primitive. In this example, 16 bits provides for up to 65,536 milliseconds (a little over a minute). According to one embodiment, a duration of 0 (represented as 16 zeros) might have special meaning, indicating that the state defined by that primitive shall be maintained indefinitely until a next primitive is received.

With reference to FIG. 6, an illustrative set of primitives may be predefined as a lighting effect. For example, a first set of primitives (illustrated in FIG. 6) that, when executed by light sources associated with lamps 401-406 result in various actions. For example, left and right light channels alternately flashing red and blue lights, thereby simulating flashing lights of a police car, may be designated as lighting effect 1. A second set of primitives that cause light sources in lamps 401-406 to gradually increase in soft yellow light, thereby simulating a rising sun, may be designated as lighting effect 2 (or 10 in binary) in this example. Yet another set of primitives that cause light sources in lamps 401-406 to gradually decrease in light, thereby simulating a setting sun, may be designated as effect 3. In illustrative embodiments, any number of lighting effects may be predefined with corresponding effect IDs known to all relevant devices. For example, lighting effects may be created to simulate a single searchlight circling overhead, multiple searchlights circling in opposite directions, a lighthouse light, headlights, stadium lights, strobe lighting, discotheque lights, dance club lights, stage lighting, light-sabers, explosions, rockets, etc. A virtually infinite number of lighting effects are possible, and are limited only by the lighting designer's creativity using the tools described herein.

Lighting effects may be defined by creatively determining sequences of lighting primitives for each of a plurality of light channels. Each light channel may be associated with a particular location of a light source corresponding to that channel. For example, in one aspect, 6 light channels may be used: front right, front left, rear right, rear left, center front, and burst channels. Each of the left, right, and center channels may be associated with a single and/or multicolor bulb as described herein, whereas the burst channel may be associated with a single bright white light source that can be used to present bright light bursts (e.g., during explosions, search lights, etc.). In another aspect, 2 additional channels may be used as well: middle left, middle right, where each middle channel is located between its respective front and rear channels, and each associated with a multicolor bulb. In other aspects, different or additional channels may be used, e.g., floor channels, ceiling channels, dim channels, strobe channels, or other special purpose channels. Special purpose channels may be associated with a special purpose light source, e.g., burst channel, strobe channel, etc. For illustrative purposes only, the remainder of this description assumes that 6 channels are being used, as illustrated in Table 1 below, where channels 401-405 use a multicolor LED bulb, and burst channel 406 uses a single color high lumen white bulb.

In additions, additional primitives may be defined for video games. For example, in car chase scenes in grand theft auto, police lights may be shown as the police are closing in on the player's vehicle. Further, headlights may appear when another car is being passed. The video games video sequences may also include lighting instructions as herein defined. These lighting instructions may appear in on-line versions of the games as well as local versions.

FIG. 6 shows an illustrative embodiment of effect 1, representative of flashing lights, such as on a police car. The channel field may be variously configured such as being 6 bits long indicating, for each lamp 401-406, whether that primitive applies to that lamp. According to an aspect, each bit may correspond to one lamp as shown in Table 1. Each lamp position in Table 1 may be individually referred to as a light channel.

TABLE 1

| Bit | Lamp |
|---|---|
| 1 | Front Left 404 |
| 2 | Rear Left 402 |
| 3 | Front Right 403 |
| 4 | Rear Right 401 |
| 5 | Center 405 |
| 6 | Burst 406 |

As shown in FIG. 6, the first primitive indicates that the left channel (front and rear left lamps) are set to full blue for ½ second. The second primitive indicates that the right channel (front and rear right lamps) are set to full red for ½ second. The third primitive indicates that the center and burst lamps are turned off until further instructions for those lamps are received. The fourth and fifth primitives indicate that the right and left channels swap red for blue, respectively.

FIG. 7 illustrates examples of primitives that may be used to define effect 2, i.e., a sunrise. The specific primitives in FIG. 7 are illustrative only, and indeed many different sets of primitives may be used to define a sunrise. In addition, multiple different sunrise effects may be predefined and be assigned different effect IDs. Each effect's design may vary depending on the desired ambiance.

In the sunrise effect example illustrated in FIG. 7, red and green light is used in combination with white light to provide an increasing soft yellow glow. A first primitive indicates that the burst channel (000001) shall remain off until further instructions for the burst channel are received. This results from a duration of 0 which, by agreement, is understood to mean that the primitive shall be maintained on that channel until an overriding primitive or instruction is received.

The remainder of the primitives examples, excepting the last primitive shown in FIG. 7, illustrate that, every 0.1 sec., the white channel is gradually increased from 0 (off) to almost full brightness (245 out of 255 intensity levels) in increments of 5. The primitive examples also illustrate that, every 0.2 sec., the red and green channels are simultaneously increased from 0 (off) to mid-range (125) in increments of 5, thereby adding a soft yellow glow to the sunrise effect. The final primitive example in FIG. 7 illustrates a final state of the sunset, where red and green lights are at intensity level 125, and white light is at intensity level 250, and duration is set to 0, thereby indicating that the lamps 401-405 should maintain the final setting until a primitive or other instruction is received that overrides the final light settings.

FIG. 7 illustrates an example sunrise effect. Other lighting designers may define other different sunrise effects, e.g., using more or less yellow light, a lower ending intensity, or using only the burst channel 406 to progress from no light to very bright light, etc. The specific set of primitives used to define each effect is secondary to the ability to define predetermined sets of primitives as effect, and then subsequently be able to execute that sequence of primitives by reference to the effect ID.

In still further examples, some effects may be defined to reference actions to be performed based on the previous effect. For example, Effect ID 2000 might indicate that the light should gradually return to a default state (e.g., whatever state the light was in prior to the start of the video program, i.e., what the viewer had set the lighting to prior to watching the video program) over some predefined or specified period of time. For example, the duration for lighting effect 2001 might indicate the amount of time over which the light should gradually return to the default state. Effect ID 2002 might be used to indicate that the final state of the previous effect should be held for the period of time specified in the duration field. Effect ID 2003 might be used to indicate a blackout, i.e., all lights off, for the period of time specified in the duration, or indefinitely if the duration is zero. Additional or different transition effects may also be defined.

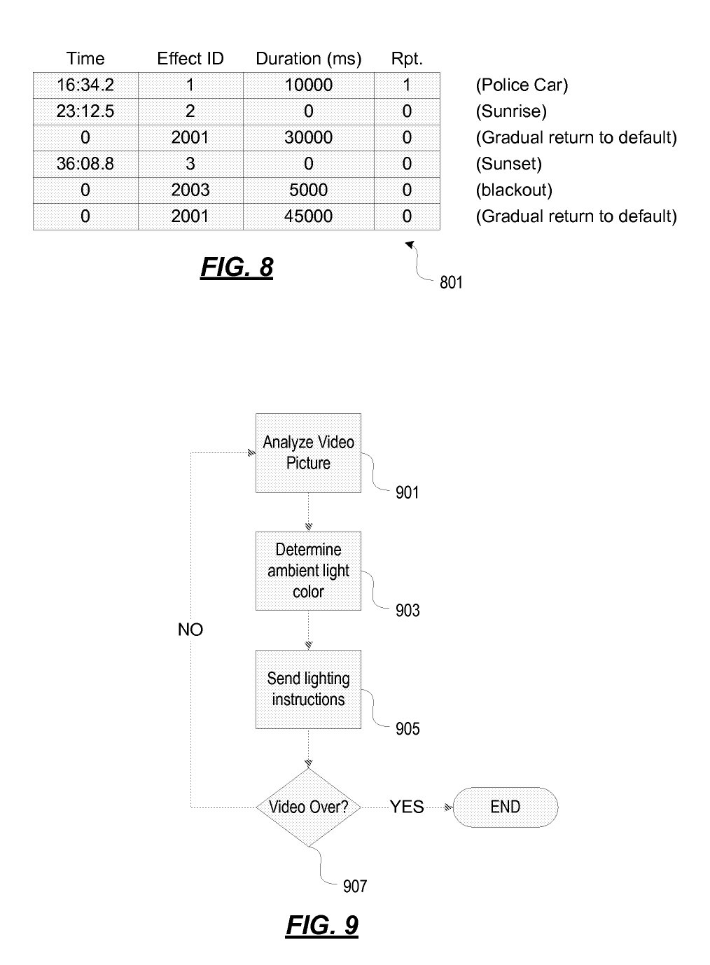

With reference to FIG. 8, an illustrative a lighting scheme 801 may be defined as a sequence of lighting effects. The scheme in this example may identify specific effects tied to particular times in a video program, may be defined as a continuous sequence of effects, or a combination of the two. FIG. 8 defines an example lighting scheme that, at 16 minutes and 34.2 seconds into a program, executes lighting Effect ID 1 (police car's flashing lights) for 10 seconds. The repeat flag is set, so Effect ID 1 will loop after completion until the 10 seconds have lapsed. Upon completion, because no transition effect is specified, each light may immediately return to its default state.

Continuing with this example, lighting scheme 801 next indicates that, at 23 minutes and 12.5 seconds, sunrise effect (Effect ID 2) is executed. The duration is set to 0, indicating that the effect is to be executed as defined by the primitives in Effect ID 2. Scheme 801 next indicates that Effect ID 2001 is executed, which by agreement refers to a gradual return to the default state of each light over the time period specified in the duration for that effect, i.e., in this example over a period of 30 seconds. The Time=0 indicates that Effect ID 2001 is to be executed immediately after the preceding effect (sunrise) is completed.

Referring to the same example, lighting scheme 801 next indicates that, at 36 minutes and 8.8 seconds, sunset effect (Effect ID 3) is executed. The duration is set to 0, indicating that the effect is to be executed as defined by the primitives defined in Effect ID 3. Scheme 801 next indicates that blackout Effect ID 2003 is immediately executed upon completion of the sunset effect, thereby causing all lights to be completely off (regardless of how the sunset effect ended) for 5 seconds. Scheme 801 next indicates that Effect ID 2001 is again executed to gradually return the lights to their default state over the time period specified in the duration for that effect, i.e., in this example over a period of 45 seconds. The Time=0 indicates that Effect ID 2001 is also to be executed immediately after the preceding effect (blackout) is completed.

Using the hardware components (lights, wireless networks, media distribution networks, etc.), primitives, effects, and schemes described above, aspects described herein provide the architecture for dynamic lighting schemes to be performed in conjunction with a media program, which will dynamically change the hue and intensity of light sources within the proximate viewing area surrounding a video in order to enhance the viewing experience.

In order to effect dynamic lighting based on the lighting primitives, effects, and schemes, in illustrative embodiments lighting controller 211 (FIG. 2) may use a ZigBee-compliant communications protocol to broadcast lighting control information for each respective light channel. Each bulb's ZigBee transceiver listens to communications received via one or more ZigBee protocols, e.g., via RF4CE over the IEEE 802.15.4 standard, as made available by the ZigBee Alliance located in San Ramon, Calif., and executes lighting instructions intended for that light source.

In some examples, before lighting primitives, effects and schemes can be effected, lighting controller 211 (FIG. 2) first executes an initialization routine to learn which light sources are located in or associated with each light channel. Many different initialization processes are possible. Regardless of which method is used, once light sources are inserted into the appropriate lamps 401-406, in illustrative embodiments lighting controller 211 learns the addresses of the light source being used for each light channel.

According to a first aspect, when each light source is manufactured it may be hardcoded to be a bulb for a specific light channel. In still further embodiments, 5.1 (“five point one”) is the common name a multi-channel surround sound (e.g., six channel) system. 5.1 surround sound is the layout used in many cinemas and in home theaters. The standard employs five full bandwidth channels and one “point one” enhancement channel. 5.1 is used in digital broadcasts. Similarly, aspects of the present invention propose extending 5.1 to ambient lighting to enhance the overall cinematic experience.

In an illustrative 5.1 ambient lighting channel system (e.g., two front, two rear, one center, and one burst), light sources may be sold in kits of 6 lights bulbs, labeled appropriately for each channel, or may be sold in kits of 5 bulbs (one for each multicolor channel), and the burst channel may be sold separately. Other combinations of bulbs may be packaged together (for example, a kit of the four front and rear bulbs only), and each bulb may also be sold individually, e.g., so a consumer can replace an individual bulb that is no longer working. In this example, where a light sources' respective channels are set at manufacturing, e.g., by hardcoding the light channel in the light source, no further setup is required beyond the user ensuring that the correct bulb is inserted into its correspondingly located lamp 401-406. Subsequently, when lighting controller 211 sends commands to a bulb designated as “front right”, any light source designated as a front right bulb may respond to those commands (regardless of where that light source is actually located). For example, the light source itself on the outer housing 301 may be labeled front left, front right, rear left, rear right, center, and/or burst. The user simply needs to place the correctly labeled light source in a lamp in the correct location. Alternately, the light sources can be dynamically programmed based on an interactive remote control. For example, a tablet device could activate each device detected in sequence and the user could simply drag an icon indicative of the active light source to a location on the tablet such as front left, front right, rear left, rear right, center, and/or burst.

According to a another example, each light source 300 may include a plurality of interactive control elements such as dip switches 323 through which a user can set each bulb to be on a designated channel. In the example shown in FIG. 3, three dip switches are provided, allowing each bulb to be designated for one of eight different channels (e.g., for use in up to a 7.1 system that provides two front, two middle, two rear, one center, and one burst light channel). More dip switches may be supplied in systems that support more than 8 channels. In this example, processor 311 may be configured to detect instructions based on the channel corresponding to the dip switch settings. This embodiment allows light source to be manufactured for universal use within a dynamic lighting system as described herein. However, more user input involvement is required during setup, e.g., confirming dip switch settings. In this aspect, light sources may still be sold in pre-configured kits. For example, in a kit of 5 light sources, while the bulbs might otherwise be identical for use in the five multi-color channels, each bulb might have its dip switches set at the factory to correspond to a different one of the five channels.

In yet another aspect, light source 300 may include a pairing button 325. Microprocessor may be configured, upon detecting that pairing button 325 has been pressed, to enter a pairing mode. While in the pairing mode, the processor may utilize a remote control and/or display screen to allow a user to input a code to assign a light source with a particular location such as front left, front right, rear left, rear right, center, and/or burst. For example, lighting controller may include instructions that execute a configuration wizard program. The configuration wizard program may cause device 200 to display various commands on display 206. For example, the wizard may cause one of the detected light sources to blink along with a display of message stating “Press the appropriate pairing button front left “1”, front right “2”, rear left “3”, rear right “4”, center “5”, and/or burst “6”.” The wizard then listens for an identification message received from user to complete the location pairing with the activated light source. In this example, when the user subsequently presses the pairing button input on the remote control, the processor thereafter associates the light source with the location selected during the pairing. In this manner, the bulb's MAC address (or other ID) is paired with location in the lighting controller 211. Lighting controller 211 records the ID as being associated with, for example, the front right channel. Similar steps may be performed for each of the other channels in use.

In yet another aspect, an RF4CE ZigBee protocol may be used to pair the lighting controller with the individual bulb devices to be controlled. Wi-Fi Protected Setup (WPS) may also be used, e.g., in combination with pairing button 325.

According to another aspect, pairing may be performed via near-field communications (NFC) or other short range RF communication using input device 208, e.g., a remote control. In such an aspect, device 200 and input device 208 may each include an NFC chip 212, 215. Device 200 may optionally include NFC chip 212 within lighting controller 211, I/O 209, or separately within device 200, as shown. Each light 301 may also include NFC circuitry, e.g., within transceiver 321, or separately. NFC chips are known in the art. Other short range RF communication standards and/or technologies may also or alternatively be used.

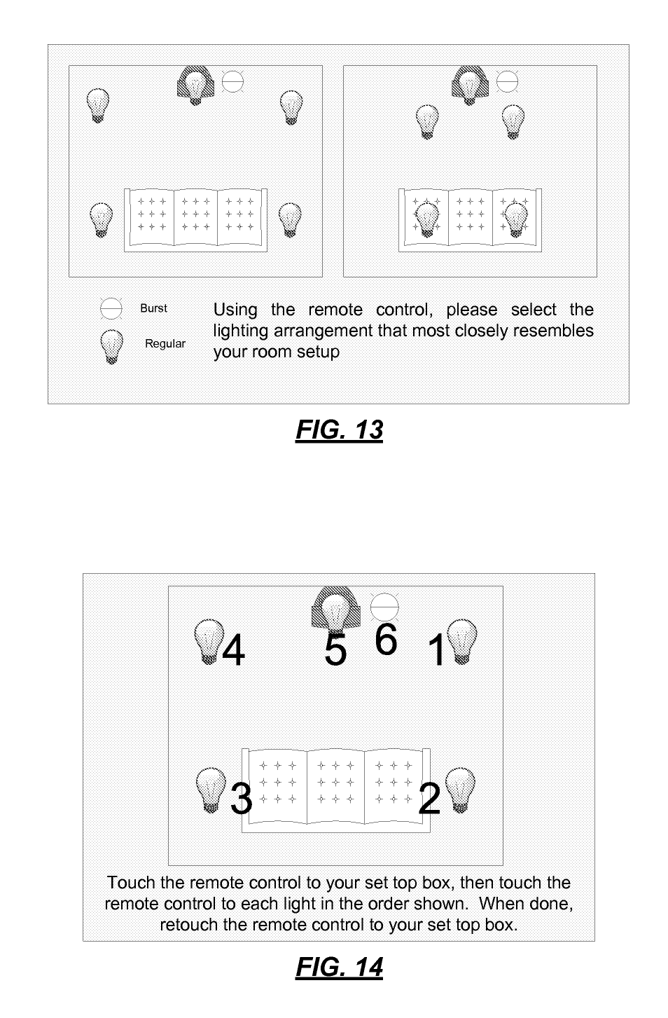

FIG. 12 illustrates a method for communicating pairing and positioning information between device 200 and one or more light sources or controllers 401-406. As used herein, pairing information may include positioning information such as location in an XYZ coordinate system, orientation information, etc., as well as other configuration information associated with a device. A user may select a lighting setup mode on device 200 to initiate the method of FIG. 12. Initially, device 200 may display one or more screens to query the user regarding the number and position of the user's lighting setup. Device 200 may first display a query asking the user regarding the number of lights. The user may provide a response via input device 208. Device 200 may next display a query asking the user regarding the general positioning of the lights. FIG. 13 illustrates a sample screen display asking the user to select light positions based on the previously entered number of lights, where the user indicated six lights, one of which is a burst channel. In FIG. 13, the room setup on the left might correspond to a room setup with free standing lamps or table lamps, whereas the room setup on the right might correspond to a room having recessed lighting in the ceiling. For purposes of this example, the user is assumed to have chosen the arrangement on the left. While only two room variations are shown in FIG. 13, device 200 may provide the user more choices based on other typical room setups. In addition, the position of the burst channel light may or may not be taken into account or needed at this point in the process. Different numbers of light may be used, e.g., 2 lights, 5 lights, 6 lights, etc.

After the number and position of the lights are selected by the user in step 1201, next in step 1203 device 200 determines an order in which the lights should be paired. The order is used by device 200 to later determine which paired light is in each position. Step 1203 may include, e.g., device 200 displaying a chart to the user, as shown in FIG. 14, indicating the order in which the user pairs the lights according to this aspect. Any order may be used, based on the assumption that the user will follow the prescribed order to pair the lights in the following steps. Whether the order is clockwise, counterclockwise, or otherwise is irrelevant, as long as the order is known.

In step 1205 the lighting controller 211 (e.g., via device 200) transfers pairing information to a transfer device. Pairing information may include configuration information. In this example, the transfer device may be input device/remote control 208, which may be provided to the user with set top box/device 200. Device 208 may be configured with NFC chip 215, as well as a processor (not shown) controlling operations of device 208, and memory (not shown) to temporarily store pairing information for transfer between device 200 and each light 401-406. The memory of device 208 may further store control logic for controlling device 208 during the transfer/exchange process. Device 208 may initiate a pairing mode of operation, during which a processor of device 208 controls communications via NFC 215 with device 200 and lights 401-406.

Pairing information may include, in an illustrative RF4CE embodiment, a personal area network (PAN) ID, MAC Address of device 200, an encryption key (e.g., an AES-128 key), a channel number, and an RF4CE address of device 200 or other shortened address to which data for device 200 (or lighting controller 211) can be sent. Pairing/configuration information may include different information needed to establish communications between device 200 and each light 401-406. Pairing/configuration information may also include a device type, e.g., where each light may need to be configured differently depending on the type of lighting controller in use. Pairing/configuration information may also include a lighting protocol identifier, e.g., where a light is configurable for use with different ambient lighting protocols. Pairing/configuration information may also include a bit rate to be used, where the lighting controller and/or light are configurable for use with different bit rate streams.

The transfer of pairing information from device 200 to device 208 may comprise placing NFC 215 of device 208 in proximity to NFC 212 of device 200, at which time device 200 sends it's pairing information to device 208 via NFC. Such NFC communication may be referred to herein as “touching” devices together to share or exchange information. Each device may have a graphic or sticker indicating a location of its internal NFC chip to identify where each device should be touched.

Next, in step 1207, the user may ensure that each light is powered on, thereby providing power to each light's NFC circuitry 321. The user may position device 208 in proximity to each light in the order prescribed by device 200 (e.g., as shown in FIG. 14), or touches device 208 to each light. When the user places device 208 near each light, each device's NFC chip is activated to exchange information. During the exchange, device 208 sends pairing information of device 200 to the light (described above), and the light sends its own pairing information back to device 208. Each light may create an entry in its own pairing table including information for device 200, after which that particular light may send and/or receive data to/from device 200.

Each light's pairing information provided to device 208 may include a MAC Address of the light, and an RF4CE address or other shortened address to which data for that light can be sent, as well as an encryption key and channel number. Optional configuration information may be included as well, e.g., light capabilities, how many colors or LEDs the light has, types of lighting formats supported, acceptable bit rates, etc. Device 208 stores each light's pairing information in its memory in such a manner that device 208 can provide to device 200 an indication of order among the information received for each light (e.g., storing in a queue, stack, or any other ordered data structure).

After “touching” device 208 to each light in the determined order, then in step 1209 the user again touches device 208 to device 200 to transfer the paring and configuration information received from each light to lighting controller 211 via NFC 212. Lighting controller 211, in step 1211, determines which light is assigned to each position/light channel based on knowing the number and arrangement of lights selected by the user in step 1201, the order in which the lights were “touched” (e.g., assumed to be as shown to the user), and the order in which the data was stored (queue, stack, numbered, etc.) and/or received from device 208. The lighting controller may also confirm the proper number of lights based on the pairing/configuration information objects downloaded from device 208. Once lighting controller 211 stores pairing information for each light, then lighting controller 211 in step 1213 can begin transmitting ambient lighting instructions in step 1213, as further described herein.

The process described with respect to FIG. 12 may be repeated anytime the user adds a light, removes a light, moves a light, and/or changes a light bulb, by selecting to repeat the lighting wizard through a user interface of device 200. Alternatively, when a user replaces a light, a similar process may be used to “clone” the replaced light. For example, when a light goes out, a user can “touch” the new light to the old light and the new light will “clone” the old light. The old light can then be switched out with the new light. Cloning may also be used with other system devices, e.g., if a user wants to use a second remote control on his system, gets a universal remote, or even wants to allow the user's phone/tablet to control a TV, and the system device has RF4CE capability, a similar RF/NFC method as described above could be used to clone the pairing info into the new device. In some embodiments, “cloning” may be performed when both light bulbs are connected to a power source, in order to power each light's respective NFC (or other RF) ship.

While NFC has been used in this example, other short range communication protocols may also be used. The method may be modified by adding steps, combining steps, or rearranging steps, provided the end result is the same, namely, pairing each light with the lighting controller, with known positions. While the above method has been described with respect to dynamic ambient lights, a similar pairing method may also be used with any other location dependent system using position-dependent devices, e.g., surround sound speakers, microphone arrays, vibration generators, smell/olfactory sources, directional wind generators, heat sources, moisture generators, and the like, in order to exchange pairing and position information in a single process. Other position-dependent devices may alternatively be used.

In illustrative embodiments, after lighting controller 211 has been configured (as necessary) to communicate with the appropriate light source for each light channel in use, lighting controller 211 may then dynamically alter room lighting based on the video program being displayed on TV 206. According to a first aspect, lighting controller 211 may dynamically alter the lighting in real-time based on a color analysis of the video program being performed or displayed. According to a second aspect, lighting controller 211 may dynamically alter the lighting based on a predefined lighting scheme corresponding to the program being performed or displayed. Each example is described in turn below.

With reference to FIG. 9, an illustrative method for dynamically altering lighting based on a real-time analysis of a video program is described. According to this example, device 200 may be configured with color analysis software stored on nonvolatile memory 205. Alternatively, color analysis software may reside in a lighting control adapter between device 200 and display 206. In other embodiments, the lighting control is performed remotely such as at the central location and downloaded along with the video content (e.g., on-line video games and/or VOD) as lighting instructions. In embodiments where color analysis software is in computing device 200, the color analysis software, when executed, in step 901 analyzes the picture being transmitted from device 200 to the TV, e.g., at a rate of 15 times per second, 30 times per second, or some other desired frequency. By examining the TV picture at a high rate (e.g., 10-60 times per second), the software in step 903 determines a background color for the lighting in the viewing area. The background color may correspond to a prominent color of the video image, a color at a periphery of the video image, or some other color selected based on the content of the video image. The color analysis software in step 905 may then send instructions to the light sources in the viewing area, e.g., via ZigBee, to adjust each light channel to specific colors and intensities as determined in step 903. In step 907, if the video program is not over, the method returns to step 901 to continue analyzing the video picture. If the video program is over, then the method ends.

According to an alternative aspect, the lighting analysis may continue until user input is received indicating user desire to end dynamic ambient lighting, rather than based on the end of a video program. In yet another alternative, device 200 may query a user at the end of a video program to determine whether to continue dynamic ambient lighting or not. Other ways of determining when the device should end ambient lighting may also or alternatively be used.

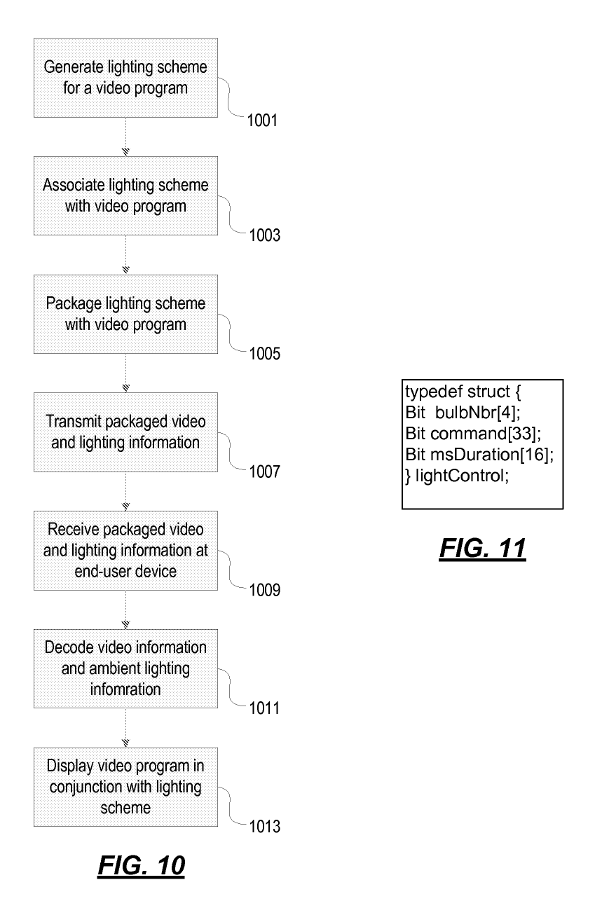

With reference to FIG. 10, an illustrative method for dynamically altering lighting based on a lighting scheme corresponding to a video program is described. According to an aspect, a video program may have a predetermining lighting scheme with which it is associated, e.g., created by an individual or entity such as the content creator or provider, created automatically by video analysis software such as video segmenting software, and/or a mixture of the two, etc. According to one aspect, producers of content can insert and send lighting instructions having one or more predetermined lighting scheme in a video stream (e.g., and MPEG-2 video stream) which can control the ambient lighting as the video is being viewed, by leveraging the capabilities described above.

In this example, in step 1001, a lighting scheme is generated based on a particular video program. The lighting designer may include a human user, using a studio application or other software, manually selecting effects to be applied within a video program, and associating those effects with specified times, durations, and/or transitions. Alternatively, the lighting designer may include automated video analysis software that automatically segments the video into various segments, detects certain events within those segments, e.g., flashing police lights, explosions, plays in a football game, touch downs, etc., and automatically applies applicable effects at corresponding times and durations in the video program, and optionally also setting a transition after the lighting effect is completed. The set of lighting effects, durations, and transitions associated with a particular video program is then saved as a lighting scheme that can be associated with that particular video program. These may be associated with the video program as lighting instructions that may be synchronized with the video either within a digital stream (e.g., MPEG stream) and/or as separate file time coded with the digital stream.

In certain examples, because multiple video schemes might be based on the same particular video program, e.g., created by two different lighting designers, in step 1003 a single lighting scheme may be selected for transmission with the particular video program. Next, in illustrative step 1005, the selected lighting scheme may be packaged for transmission with the particular video program. According to one aspect, packaging may include saving the video program and lighting scheme as a single file or set of associated files in a predetermined format for sending over a desired delivery platform. For example, in one aspect the selected lighting scheme may be intended to be sent in a synchronized MPEG-2 and/or MPEG-4 stream, e.g., using enhanced binary interchange format (EBIF), to transmit the ambient lighting scheme in a time-synchronized manner with the video program. In such an environment, the video program and lighting scheme may be saved in a format for immediate or near immediate transmissions, with little or no conversion required before transmission. In other embodiments, the files are sent as separate files and then time coded to particular segments of the MPEG stream.

In illustrative step 1007 the packaged file is transmitted to a media consumer device. Transmission may occur at or initiate from a headend 103 or other media distribution location. In step 1009 the transmission is received by a media device, e.g., device 200, a set-top box (STB), digital video recorder (DVR), computer server, or any other desired computing device capable of receiving and decoding the transmission.

In illustrative step 1011, the media device decodes the transmission into a video program and a lighting scheme, and forwards each portion to applicable hardware for further handling. In illustrative step 1013 the media device outputs the video program portion of the transmission for display on a video display screen, e.g., display 206. In this illustrative method, the media device outputs the lighting scheme to lighting controller 211 for control of an ambient lighting system as described herein. Based on the time-based information in each of the video program and the lighting scheme, the video and illustrative ambient lighting information may be performed in synchronicity with each other, thereby rendering the lighting scheme in conjunction with the video program as intended by the lighting designer.

The above aspects and information describe only one possible implementation of the dynamic ambient lighting system and methods thus far described. Many variations and alternatives are possible that allow a system to remotely control multiple light sources, using a synchronized transport stream (e.g., an MPEG-2 transport stream) or an asynchronous transmission as its communications path. A system remote from individual light sources themselves can thereby control lighting in predefined ways. For example, a movie might have encoded within its MPEG-2 transport stream, instructions for lighting in the room where the movie is being viewed. A scene in the movie might have police lights flashing. A remote command might be sent to specific bulbs in the viewing room to flash red and blue. The result is an intelligent expansion of the viewing platform.

In another illustrative embodiment, a lighting controller might query a lighting scheme database (e.g., over network 109, 210, the Internet, etc.) based on a program ID of received video content. If a lighting scheme is identified as a result of the query, the lighting controller (or other applicable component) might download the lighting scheme from the lighting scheme database for use during playback of the video content, as described herein. If more than one lighting scheme is identified as a result of the query, the lighting controller (or another applicable component) might query the user to determine which lighting scheme should be used, or may pick a lighting scheme automatically, e.g., based on an author of the lighting scheme, popularity, user feedback or reviews, or based on other information known about the lighting scheme. Once selected and downloaded, the lighting controller uses the selected lighting scheme to control ambient lighting during playback of the video content, as described herein.

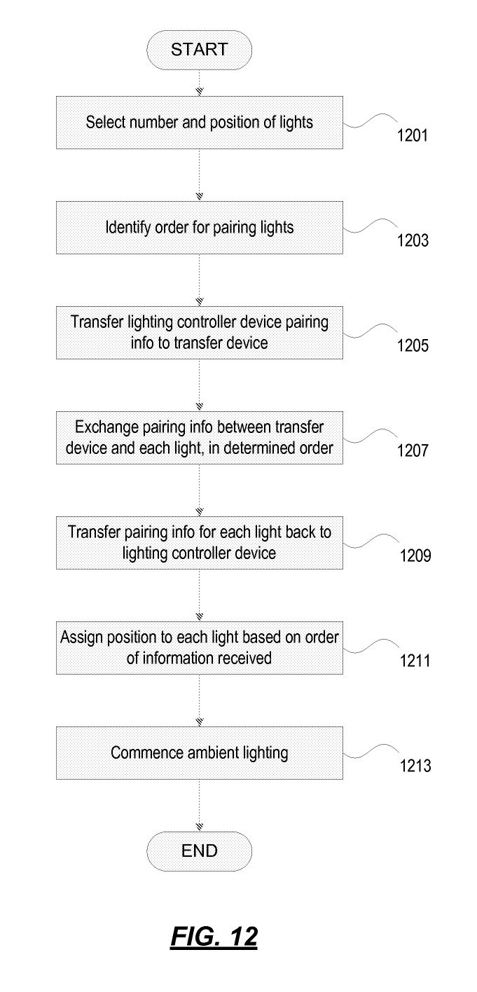

According to one example, instead of the format shown in FIG. 5, a primitive may have the type definition illustrated in FIG. 11. Based on the structure shown in FIG. 11 for the primitive defined as lightControl, the command element may have as its most significant bit a flag enabling/disabling raw mode. When set to 0, then the following 4 bytes are composed of white, red, blue, and greed, each having 8 bits (32 bits in total) in which to convey the “raw mode” intensity value for each LED strand. When set to 1, then the following 4 bytes are used to identify a specific, agreed upon, lighting effect (or combination of lighting effects, as a sort of lighting macro). The range of integer values which can be stored in 32 bits, is 4,294,967,295. Thus there are over 4 billion possible lighting effect commands which could be predefined, optionally for each light source. The bulbNbr attribute provides 4 bits (maximum of 16 possibilities) to define the light source for which the command is intended. Thus any ambient lighting system could be used with up to 16 individual light channels. The msDuration attribute defines the number of milliseconds to apply the command, with a maximum of 65,536 milliseconds (just over 1 minute, 5 seconds) based on the 16 bit value of that field.

According to another example, the synchronized lighting scheme data, upon encapsulation within the MPEG transport stream, may be encapsulated into descriptor elements as “proprietary data” as that term is utilized in the MPEG standards. In one embodiment, the lighting instructions may be packaged as proprietary data and identified within a Program Map Table of the client device or gateway. This meta data can be utilized by the computing device 200 to control lighting and also by the program guide to show programs which are ambient lighting enabled. The computer device 200 may be configured to check the descriptor elements including the proprietary data in order recognizes that the type of proprietary data is a type which includes lighting instructions. For example, a type from within the PMT may be used, and the binary stream, synchronized to the concurrently received video and audio stream. Upon reading the lighting instructions, the computing device may be configured to broadcast data associated with the lighting instructions to 802.15.4 radio receivers embedded within each light channel's light source. According to this aspect, each light source may be configured with a specific identification. Using the field within the lightControl packet structure to determine whether the lighting control message is meant for it, a light source's processor determines whether that light source should implement the lighting instruction it has received. As discussed above, a lighting instruction might be a simple set of intensity values for each LED strand, e.g., a primitive, or alternatively the lighting instruction could be a more complex lighting effect, perhaps lasting many seconds.

According to other aspects, ambient lighting may be used to signify external events in or around the viewing area. For example, when a loud video program is playing, it may be difficult for a viewer to hear the telephone ring. Currently, media distribution systems tie in to the telephone line and may display caller ID information on a television or other display apparatus. According to an inventive aspect herein, the lighting controller may be configured to perform a specific lighting effect or scheme when a telephone rings or upon the occurrence of other predefined events not associated with the video program being watched. For example, when the phone rings, the lighting controller may cause the ambient lights to perform a strobe effect. In another example, when a doorbell is rung the lighting controller may cause the ambient lights to repeatedly transition from dim to bright and vice versa, or some other predefined effect. The processor 200 may also be configured to act as an alarm clock and have the lighting activated responsive to an alarm event such as a predetermine wakeup hour. Further, the lighting may be responsive to other events such as the laundry ending, the stove timer, the dish washer, etc. Predetermined effects may include any desired light channel(s), colors, strobes, durations, patterns, etc. The auxiliary devices such as laundry may be tied in via network 210.

According to some aspects described herein, a set-top-box or other media device may be configured to output the lighting scheme portion of the transport stream via USB or HDMI (e.g., over the consumer electronics control (CEC) data path) to an external device that includes the lighting controller and/or associated wireless transmitter. This configuration allows for set top boxes or other devices currently available, which do not have the requisite hardware installed for use in the described ambient lighting control system(s) to be retrofitted for such use. In another variation, a Digital to Analog (DTA) adapter may be used to receive streamed (e.g., via MPEG-2) lighting instructions. The latest generation of these devices includes RF4CE transmitter capability, thus there would be no need for an external adapter. The DTA adapter, in such an embodiment, may also transmit the lighting instructions to the light sources using the RF4CE transmitter.

As described above, aspects described herein are not limited to dynamic ambient lighting. With reference back to FIG. 2, each device controlled in synchronization with a media program may include dynamic lights, toys, sound generators, wind generators, olfactory emitters, lasers, smoke machines, heat sources, rain generators, microphones, or any other device that can communicate with a device controller.

FIG. 15 illustrates a generic data (e.g., media) packet that may be used to control an object such as a dynamic device 220. Media or data packet 1500 may also be referred to as a dynamic media packet. Media packet 1500 may include or alternatively be formatted similar to primitive 500 (FIG. 5), the structure illustrated in FIG. 8, and/or the structure illustrated in FIG. 11. Each data packet 1500 may include a first data field for communicating a program ID corresponding to a media program for which the instruction is intended. Program ID 1501 may be optional if the data packet is received as part of a data stream in which the media program is also communicated. However, in an embodiment where the data packet may be sent separately from the data stream for the media program, the program ID 1501 may be used to correlate the data packet to the proper media program. Data packet 1500 may also include a timestamp 1505 indicating a time within a media program associated with the data pack that the payload instructions should be executed.

Data packet 1500 may also include a device ID 1503 identifying a particular dynamic device 220, e.g., to distinguish between lighting, toys, wind generators, etc. The device ID 1503 may reference a particular device, or may reference a device type or genre. Device ID 1503 may refer, for example, to classes of devices, e.g., wind generators, olfactory emitters, lasers, etc., and if device controller is in communication with any of the device or type of device specific, may act upon the received data packet at the timestamp indicated. For example, the device ID may indicate a value corresponding only to a single type of stuffed animal (e.g., an elephant) that has built in electronics for movement of the elephant's trunk, memory for storing one or more audio clips, and a speaker for playback of the stored audio clip in synchronization with a media program. Alternatively, the device ID may indicate a value corresponding to a genre of devices that have predetermined capabilities corresponding to that device ID. For example, the device ID may correspond to any plush toy or other device having memory for storing audio clips and a speaking for playing the stored audio clips, regardless of whether device 220 is an elephant, bear, tree, cube, etc.

Data packet 1500 may also include payload 1507 including all information and/or instructions necessary for the device(s) identified by Device ID 1503 to perform some action at the time identified by timestamp 1505 during the media program identified by Program ID 1501. Payload 1507, e.g., may include a command instructing device 220 to play stored audio clip 1 at time 4:17 of a specified media program. Alternatively, payload 1507 may include the audio clip to be played by device 220, as well as a command to play the audio clip at a particular time. In still other embodiments, payload 1507 may include one or more lighting instructions for a dynamic light device as described above. Payload 1507 may include instructions defining an intensity of wind for a wind generator, as well as times to start and/or stop blowing wind at the specific intensity. An infinite number of possibilities exist for different types of dynamic devices to be synchronized to playback of a media program. The specific information in packet 1500 is secondary to the ability to synchronize some action performed by a dynamic device with playback of a media program based on information contained in media packet 1500.

In some embodiments, the payload instructions may be predetermined according to an adopted standard or protocol. In other embodiments, the payload instructions may be particular or specific to a device or genre of devices. In other embodiments, a combination of the two may be used.

Media packet 1500, or a stream of media packets 1500, may be included within an MPEG media stream delivering one or more media programs to a user device (e.g., to a television, set-top-box, computer, media server, etc.). Device controller 211 may store a lookup table or database of devices in communication with the device controller. Device controller 211 may then determine, upon receiving a media packet 1500 in a media stream, whether device controller 211 is in communication with a device 220, 300 that corresponds to Device ID 1503. When device controller 211 is in communication with such a device, controller 211 may send the payload to corresponding device for execution at the time specified by timestamp 1505. In one embodiment, controller 211 might not send payload 1507 to the relevant device until timestamp 1505, at which time the device 220 executes the instructions immediately upon receipt. In another embodiment, controller 211 might send payload 1507 (or a preset delay) to the relevant device along with timestamp 1505, and the device 220 then waits until timestamp 1505 (or until the delay has expired) before executing the instructions in payload 1507.

In embodiments where the payload instructions are not executed instantly by a device 220, the delay is preferably minimized to ensure that the user is still watching the media program to which media packet 1500 corresponds. That is, the user may change a television channel, or otherwise navigate away from the media program associated with media packet 1500 before payload 1507 of media packet 1500 is executed by device 220. As a result, the user may be watching a different media program when the instruction is executed, causing confusion to the user. The delay or other advance notification of a media packet to a device 220 should therefore be minimized to reduce this possibility. Alternatively, when a user changes a channel or navigates away from a media program, device controller 211 may be adapted to send a cancellation message to a device 220 for any sent, but unexecuted, payload instructions.

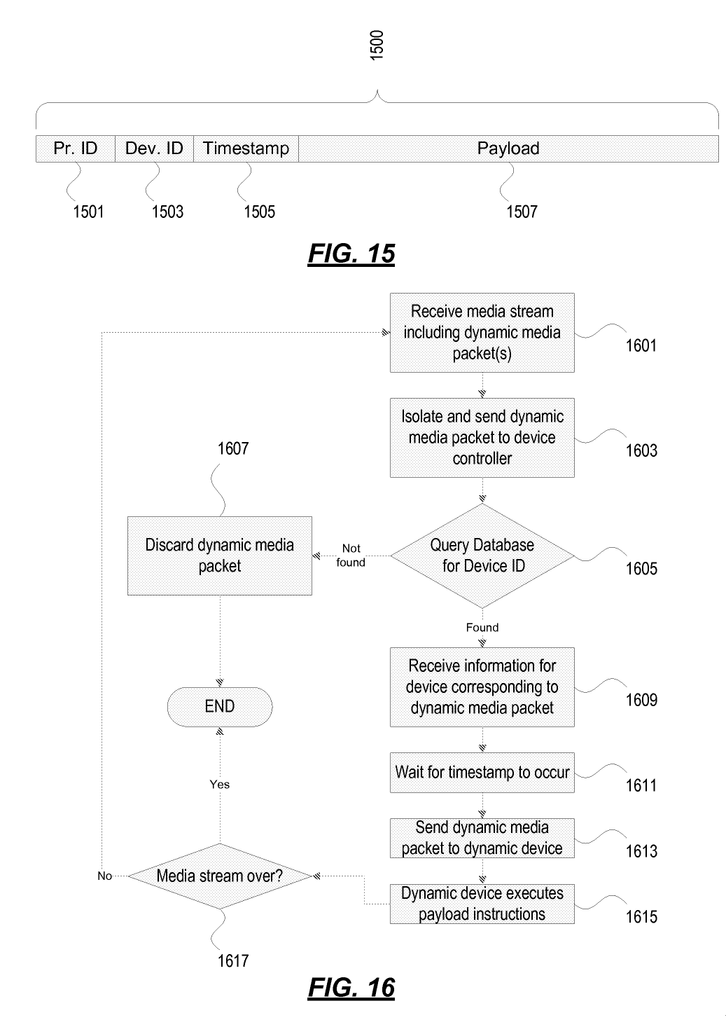

FIG. 16 depicts a method of dynamically controlling one or more devices according to an illustrative aspect. Initially, in step 1601, device 200 receives a media stream in which a dynamic media packet is included, e.g., receiving an MPEG media stream through network I/O 209. In step 1603, processor 203 parses the media stream (e.g., to separate audio and video portions of the stream), and sends the dynamic media packet to device controller 211. In step 1605, device controller 211 queries a stored device database for the device ID identified in the dynamic media packet. If the device ID is not found, then in step 1607 device controller 211 discards the dynamic media packet. However, if the device ID is found, then in step 1609 device controller 211 receives, in response to the query, device information for the device 220 corresponding to the device ID of the dynamic media packet, and stores the dynamic media packet in memory. The device information may include any information needed by device 211 to wirelessly communicate with that particular dynamic device, e.g., a network address, channel, etc.

In step 1611 device controller 211 waits for timestamp 1505 to occur during playback of media program 1501. In another aspect, waiting for a time stamp might not occur, and the payload instructions may be sent immediately upon processing. When controller 211 detects that media program 1501 is at or near timestamp 1505, then in step 1613 device controller 211 sends payload instructions 1507 to the dynamic device 220 identified in step 1609, e.g., via wireless communications, RF4CE, ZigBee protocols, etc. In step 1615 dynamic device 220 executes the received payload instructions to occur at or near timestamp 1505. In step 1617, if the media stream continues, then device 200 continues to receive the media stream back in step 1601.

In some aspects, the method described above may be modified, e.g., to include the timestamp in the information sent to each device 220, which may be used by device 220 to ensure that execution of the payload instructions occurs at a particular time. The method may also be altered to send cancellation instructions to a device when a previously sent payload has been sent to the device, the payload has not yet been acted upon by the device, and the user has changed channels or otherwise navigated away from the media program with which the payload is associated. In some embodiments, steps may be combined, split and/or reordered.

As described herein, instructions (dynamic media packets) for execution by a dynamic device may be embedded in an MPEG stream, e.g., an MPEG-2 program stream sent over a media distribution network. The instructions may be decoded by a media consumption device such as a set top box, home gateway, media server, computer, or similarly configured devices. Each dynamic media packet contains information for execution by a dynamic device in synchronization with playback of a media program or other video stream. Communication between a device controller and a dynamic device may be in accordance with 802.15.4 chipsets (e.g., according to ZigBee and/or RF4CE protocols), or in accordance with other standards and/or protocols. The dynamic device receiving the instructions then executes the instructions to play a sound, generate wind, alter lighting, ring a chime, generate fog or smoke, or perform any other action identified in a dynamic media packet and which the dynamic device is capable of performing.

According to aspects described herein, interactivity may be controlled by the video rendering device (e.g., TV), or any other computing device (e.g., set top box, device controller 211, etc.) which has information about the current media time of the program which is being watched.

According to an aspect, a set top box or other device 200 may download a set of triggers (e.g., predefined or preset dynamic media packets) from a web-server. Each trigger may be or include a UPnP action corresponding to a media time or timestamp. In another case, these could be a series of tuples with UPnP actions, timestamp and activation parameters (program ID, device ID, business rules, and/or other parameters determining when the UPnP action should be performed).

Device 200 may discover all dynamic devices within a premises using a wireless universal plug-and-play (UPnP) protocol, store device information in a lookup table or database for future reference (e.g., during step 1605 above) and then invoke UPnP actions corresponding to the defined triggers when the conditions for the trigger are met. The triggers and conditions may be included in dynamic media packets. When a condition or trigger is based on additional information beyond program ID, device ID, and timestamp, any such additional requirements may be included in payload 1507, or the format of dynamic media packet 1500 may be altered to include additional or different fields, as needed.

According to an illustrative use case, a user may purchase a set of stuffed toys, such as characters from Sesame Street®, which will speak along with a Sesame Street show. The video stream in which the show is sent to end-user devices may be customized with dynamic media packets instructing the stuffed toy characters talk in a personalized manner, or in supplement to the show.

According to an additional aspect the media program itself may be altered based on the characters that are present in a particular premises and tailor the dialog/interactivity based on the dynamic devices present. For example, after receiving device 200 registers one or more dynamic devices 220, device 200 may communicate with a server over a network 210 such as the Internet, and identify the dynamic devices associated with that receiving device 200. When a user instructs device 200 to tune to a particular channel or to play a particular media program, a server device 103 serving content to device 200 may select a media stream based on the devices 220 known to be associated with device 200. In this manner, a portion of dialogue associated with a television program or other media program may be spoken by one or more of the dynamic devices 220, rather than output via a speaker associated with a television set or stereo system. Alternatively, a single media stream may include separate audio channels for dialog by different characters, and device 200 may send audio associated with a particular character to a corresponding dynamic device when a dynamic device has previously been registered for that character, or device 200 may send audio associated with that particular character to a default speaker when a dynamic device has not been previously been registered for that character.

For example, central location 103 (e.g., a headend, local office, or other media distribution location), upon receiving a request from device 200 to tune to a Sesame Street media program, may determine that device 200 is known to be associated with dynamic devices having device IDs corresponding to the Big Bird and Oscar the Grouch characters in the show. Each of the Big Bird and Oscar the Grouch dynamic devices may be known to have memory for storing audio clips, a processor, animatronics (or other mechanical actuators) to move the mouths of the respective characters, and a speaker for playback of the stored audio clips. Headend 103 may then select a version of the Sesame Street media program that replaces some or all of the dialog for the characters Big Bird and/or Oscar in the media program with one or more dynamic media packets storing replacement dialog to be spoken by the corresponding Big Bird and Oscar the Grouch dynamic devices, with corresponding instructions to move the mouths of the characters in concert with playback. Alternatively, the media program might not be altered, but may instead include separate audio channels for each characters dialog. Device 200 may send audio output corresponding to dialog by Big Bird and Oscar the Grouch to device controller 211 for transmission to the Big Bird and Oscar the Grouch dynamic devices, respectively, and may send the remainder of the audio channels to an audio processor output via default speaker or speakers.

In another example, dynamic media packets may be inserted into a media stream dynamically, based on events occurring the media program. For example, a producer of the broadcast of a football game may instruct a broadcast computer to insert a dynamic media packet when a team scores. A remote control, motorized (e.g., electromechanically actuated) football action figure may be controlled to spin around in response to the inserted dynamic media packet.

In another example, an advertiser may give away a dynamic device that responds (animates, plays sound, etc.) to that advertisers television commercials. For example, a Dunkin Donuts coffee cup may lift its lid and play a melody in response to dynamic media packets included in a Dunkin Donuts commercial. The melody may be preloaded on the dynamic device, or included within the dynamic media packets.

It will thus be appreciated and understood that modifications may be made without departing from the true spirit and scope of the present disclosure. The description is thus to be regarded as illustrative instead of restrictive on the present disclosure.

What is claimed is:

1. A method comprising:
receiving a media transmission over a network connection, said media transmission comprising an audio component, a video component, and at least one dynamic media packet;
outputting the video component to a video display device;
outputting the audio component to one or more speakers; and
outputting instructions associated with the at least one dynamic media packet to an object associated with the dynamic media packet, wherein the instructions identify an action to be performed by the object at a predefined time associated with the media transmission.

2. The method of claim 1, wherein the dynamic media packet comprises:
a program ID;
an object ID;
a timestamp; and
instructions defining an action to be performed by the object associated with the dynamic device ID during playback of a media program identified by the program ID, and to occur at a time within the media program identified by the timestamp.

3. The method of claim 1, further comprising waiting for the predefined time within the media transmission before outputting the instructions associated with the dynamic media packet to the object associated with the dynamic media packet.

4. The method of claim 1, wherein outputting instructions comprises transmitting the instructions over an RF4CE protocol.

5. The method of claim 1, wherein the output instructions comprise an action to be performed by the object, and a time at which the object is to perform the action.

6. The method of claim 1, wherein the object comprises a speaker, and the instructions comprise audio to be played over the speaker of the object.

7. The method of claim 1, wherein the object comprises a light, and the instructions comprise lighting instructions.

8. The method of claim 1, wherein the object comprises an electromechanical actuator; and the instructions result in actuation of the electromechanical actuator.

9. The method of claim 1, wherein the dynamic media packet is inserted into the media transmission at a broadcast location of a live event.

10. A device comprising:
a processor; and
memory storing instructions that, when executed by the processor, configure the device to perform:
receiving a media transmission, said media transmission comprising an audio component, a video component, and at least one dynamic media packet;
outputting the video component;
outputting the audio component; and
outputting instructions associated with the at least one dynamic media packet via a wireless transmitter to an object associated with the at least one dynamic media packet, wherein the instructions identify an action to be performed by the object at a predefined time corresponding to the media transmission.

11. The apparatus of claim 10, wherein the dynamic media packet comprises:
a program ID;
an object ID;
a timestamp; and
instructions defining an action to be performed by the object associated with the object ID during playback of a media program identified by the program ID, and to occur at a time within the media program identified by the timestamp.

12. The apparatus of claim 10, wherein the instruction further configure the apparatus to perform: waiting for the predefined time within the media transmission before outputting the instructions associated with the dynamic media packet to the object associated with the dynamic media packet.

13. The apparatus of claim 10, wherein outputting instructions comprises transmitting the instructions over an RF4CE protocol.

14. The apparatus of claim 10, wherein the output instructions comprise an action to be performed by the object, and a time at which the object is to perform the action.

15. The apparatus of claim 10, wherein the object comprises a speaker, and the instructions comprise audio to be played over the speaker of the object.

16. The apparatus of claim 10, wherein the instructions define an actuation of an electromechanical actuator associated with the object.

17. The apparatus of claim 10, wherein the instruction further configure the apparatus to perform:
determining that a portion of the audio component corresponds to the object; and
outputting the portion of the audio component to the object instead of to an audio port.

18. A method comprising:
receiving a request from a first user device for a media program;
determining a first set of one or more dynamic objects known to be associated with the first user device;
determining a first version of the media program, from a plurality of versions of the media program, based on the first set of one or more dynamic objects; and
transmitting the first version of the media program to the first user device.

19. The device of claim 18, wherein the instructions further configure the device to perform:
receiving a request from a second user device for the media program;
determining a second set of one or more dynamic objects known to be associated with the second user device, wherein said second set is different from said first set;
determining a second version of the media program, from a plurality of versions of the media program, based on the second set of one or more dynamic objects, wherein the second version is different than the first version; and
transmitting the second version of the media program to the second user device.

20. The device of claim 19, wherein the first version is a default version containing a complete audio track, and wherein the second version is a modified version replacing a portion of the audio track with one or more dynamic media packets defining instructions to play the replaced portion of the audio track via the second set of one or more dynamic objects.
